(19) United States
(12) Patent Application Publication
(10) Pub. No.: US 2019/0324295 A1
(43) Pub. Date: Oct. 24, 2019

(54) Interchangeable Jewelry Clip

(71) Applicant: Alessandra Marzano, Miami Beach, FL (US)

(72) Inventor: Alessandra Marzano, Miami Beach, FL (US)

(21) Appl. No.: 15/956,589

(22) Filed: Apr. 18, 2018

(51) Int. Cl. G02C 11/02; A44C 25/00

(52) U.S. Cl. CPC G02C 11/02; A44C 13/00; A44C 25/007

(57) ABSTRACT

This is an interchangeable jewelry clip that attaches to the temple of a pair of eyeglasses and allows for charms or other devices to be attached. This allows a user to further customize his or her eyeglasses as he or she desires. The charms that attach to the clip can be interchanged with the clip or permanently attached to the clip.

### BACKGROUND OF THE INVENTION

This invention relates to a jewelry clip that attaches to the temple of a pair of eye glasses. Eye glasses are a necessity for many individuals in today's society and it is very common for children as well as adults to have the desire to personalize their glasses. While an individual in need of eye glasses has many aesthetically pleasing options to choose from, there is not an option that allows for attaching an interchangeable jewelry clip, as described and claimed herein, to the temples of the glasses. The claimed invention allows a child or adult to further personalize his or her glasses.

### BRIEF SUMMARY OF THE INVENTION

This invention is for an attachable clip for the temples of eyeglasses that allows for interchangeable charms to be attached. The clip provides a hinged clasp that allows the clip to wrap around the temple of the glasses. The clasp additionally provides a friction pad and integrated connectors. The friction pad is intended to ensure that the clasp remains secured in its place after the hinged clasp is closed around the temple of the eyeglasses.

The integrated clip connectors will connect with a separate device such as a charm. The charm would provide its own connectors that mate with the integrated clip connectors. While a charm is discussed and described as being attached to the clip, it is anticipated that another device may alternatively be attached.

### BRIEF DESCRIPTION OF THE DRAWINGS

FIG. 1 is a side view showing the clip with the clasp of the clip in an open position, the friction pad, and the integrated clip connectors.

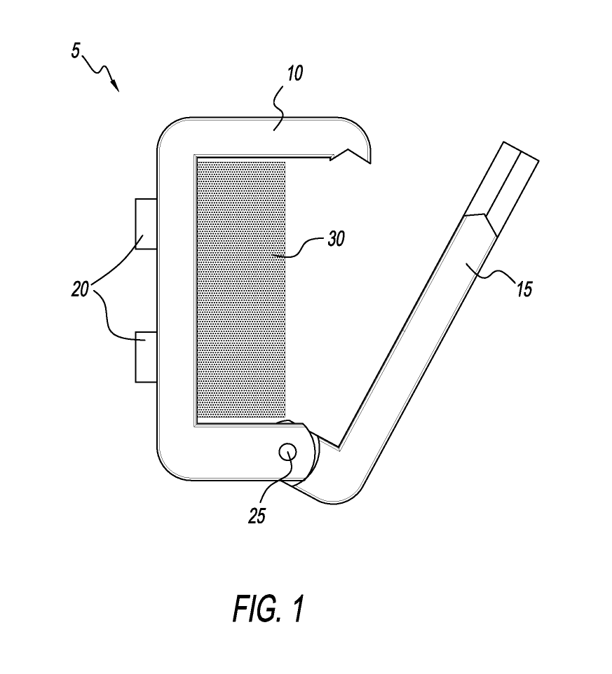

FIG. 2 is a top view showing the clip with the clasp of the clip in a closed position and the integrated clip connectors.

FIG. 3 is front view showing the clip with the clasp of the clip in a closed position and the integrated clip connectors.

FIG. 4 is an isometric exploded view showing the clip with the clasp, the hinge pin, and the friction pad.

FIG. 5 is a side view of the device showing the integrated connectors of the clip connect with the connectors of the charm.

FIG. 6 is a front isometric in use view of the device showing the device attached to the temple of a pair of eyeglasses.

FIG. 7 is a back isometric in use view of the device showing the device attached to the temple of a pair of eyeglasses.

### NUMBERING REFERENCE

5—Device
10—Clip
15—Clasp
20—Plurality of integrated connectors
25—Hinge pin
30—Friction pad

### DETAILED DESCRIPTION OF THE EMBODIMENTS

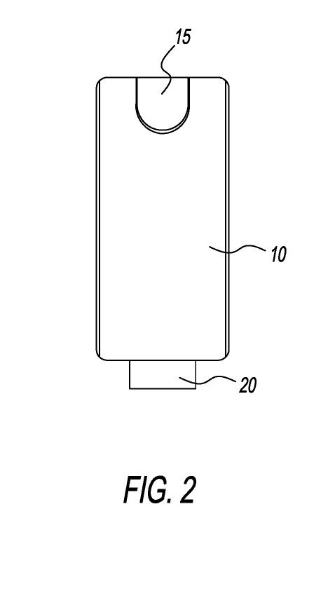

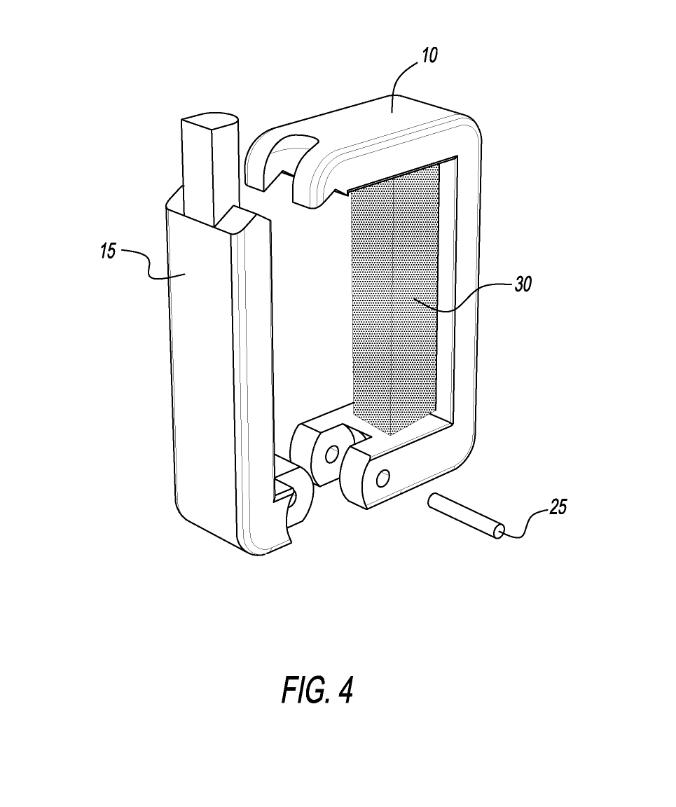

This device 5 is an interchangeable jewelry clip for eyeglasses that is capable of being secured to the temple of a pair of eyeglasses and connects to a charm. While this is invention is described as being used with eyeglasses, it may also be used on the temple of sunglasses, keychains, clothing, bags or other accessories. The interchangeable jewelry clip 5 is comprised of a clip 10 with a clasp 15 a plurality of integrated clip connectors 20, a hinge pin 25, and a friction pad 30. The clip 10 is further comprised of a top, a side, and a bottom. The top of the clip has a first end and second end. The side of the clip has a first end and a second end. The bottom of the clip provides a first end and a second end. Also, the top, side, and bottom of the clip each provide an interior surface and an exterior surface. The second end of the top of the clip 10 provides a concave surface, which is shown in FIG. 2 and FIG. 4. The clasp 15 provides a first end, a second end, an interior surface, and an exterior surface.

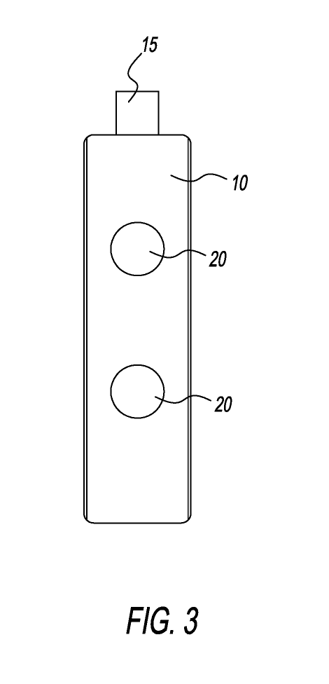

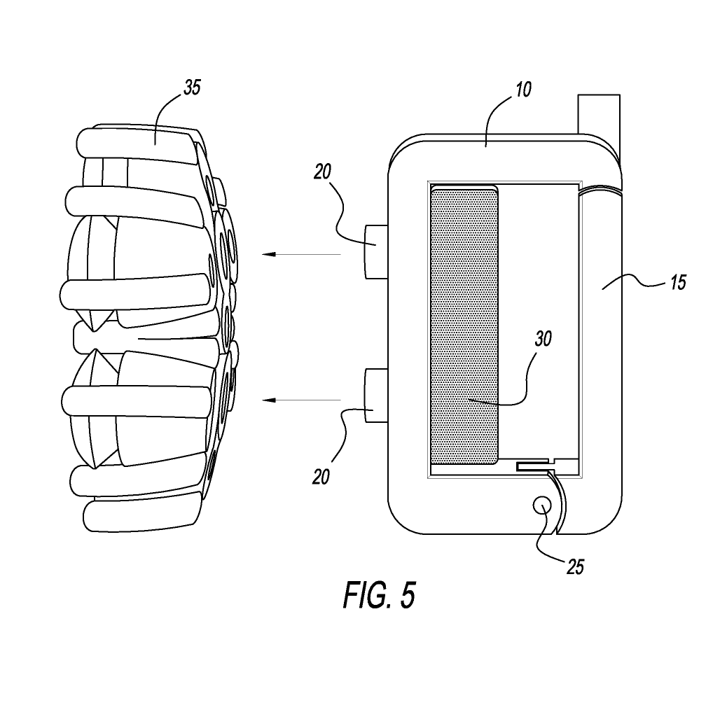

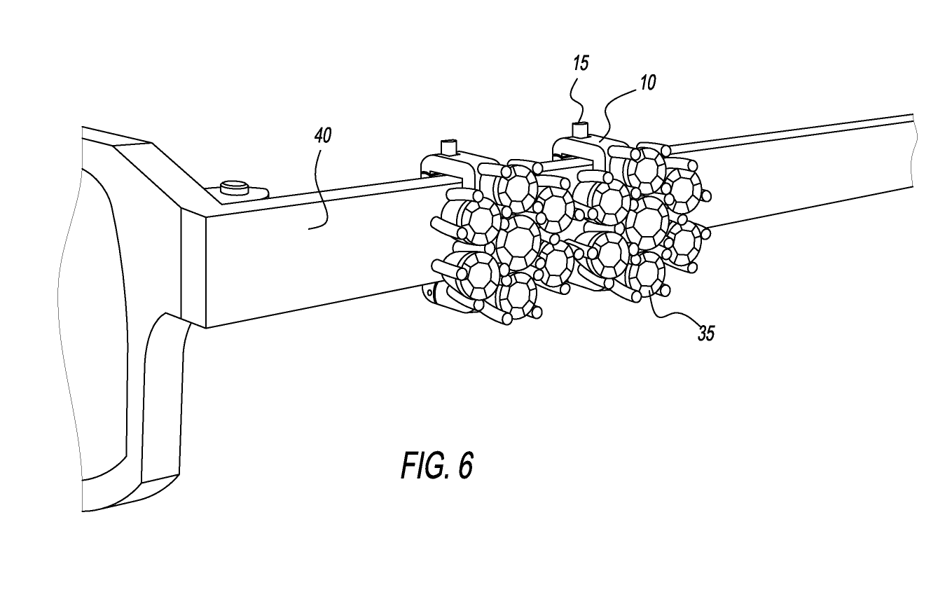

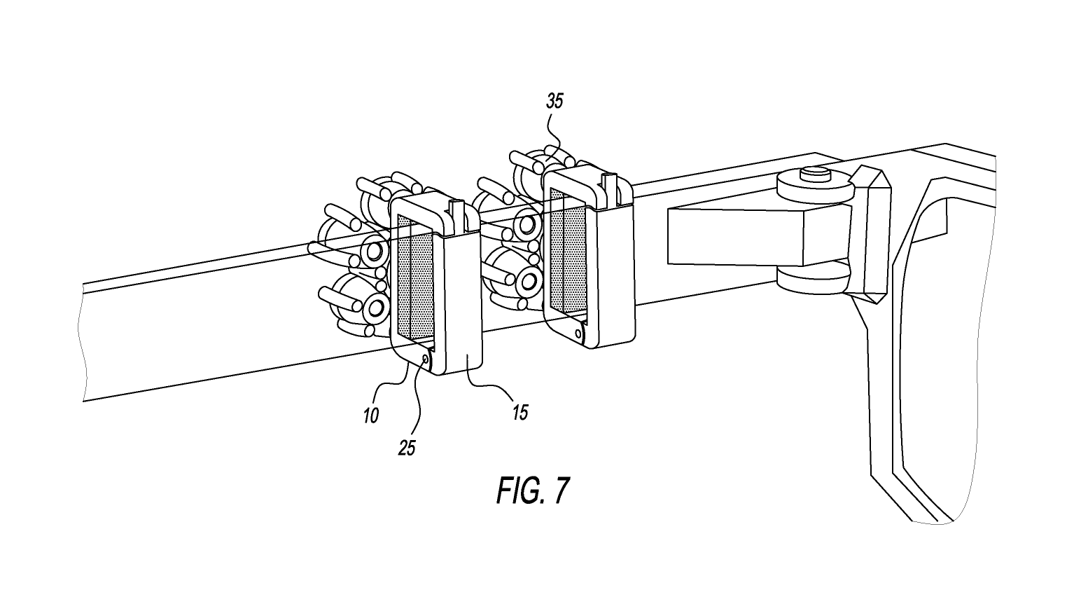

The clasp 15 opens and closes along a hinge and is connected to the clip 10 with a hinge pin 25. It is anticipated that the hinge pin 25 can be hidden from view. A user is to place the clasp 15 in an open position. Once the clasp 15 is brought to a closed position the first end of the clasp 15 provides a convex surface that extends above the top of the clip 10 and fits within the concave surface at the second end of the top of the clip 10, which is shown in FIG. 3, FIG. 5, FIG. 6, and FIG. 7. Accordingly, the first end of the clasp 15 is used by a user to press with a finger to open and close the clasp 15.

The side of the clip 10 provides a friction pad 30 on its interior surface. The friction pad 30 is anticipated to be made of silicone, but could be made of any semi-flexible material that can compress against the temple of a pair of eyeglasses to create friction. Once the clasp 15 is closed, the friction pad 30 allows the clip 10 to fit on a variety of temples each having differences in thickness. The friction pad 30 will additionally prevent damage occurring to the eye glasses.

It is anticipated that the friction pad 30 could be alternatively provided on the clasp 15. Also, an additional alternative embodiment is that more than one friction pad 30 could be provided. For example, a first friction pad 30 could be provided on the interior surface of the side of the clip 10 and a second friction pad 30 could be provided on the interior side of the clasp 15.

The exterior surface of the side of the clip 10 provides a plurality of connectors 20 that are integrated into the side of the clip 10. The plurality of integrated connectors 20 are then utilized to connect with a charm as shown in FIG. 5. While the plurality of connectors are shown to extend from the exterior surface of the side of the clip 10, it is anticipated that only one connector 20 could alternatively be provided. It is additionally anticipated that the plurality of integrated connectors 20 can be a different shape. However, the shape of the connector will have to connect or mate respectively with the charm.

Although this invention is shown and described as providing connectors 20 to allow for interchangeable charms, it is anticipated that alternatively the clip and charm can be permanently attached to each other. Accordingly, if the user desires to change the charm, he or she will have to remove the clip 10 attached to the charm and place a new clip 10 with its own charm on the temple of the glasses.

While the embodiments of the invention have been disclosed, certain modifications may be made by those skilled in the art to modify the invention without departing from the spirit of the invention.

The inventor claims:

1. A device that is comprised of:
a. a clip;
wherein the clip provides a top, a side, and a bottom;
wherein the top has an exterior surface and an interior surface;
wherein the top has a first end and a second end;
wherein the second end of the top of the clip has a concave surface;
wherein the side has an exterior surface and an interior surface;
wherein the side has a first end and a second end;
wherein the bottom has an exterior surface and an interior surface;
wherein the bottom has a first end and a second end;
wherein the second end of the bottom has a hinge;
b. a clasp;
wherein the clasp has an exterior surface and an interior surface;
wherein the clasp has a first end and a second end;
wherein first end of the clasp has a convex surface;
wherein the convex surface fits within the concave surface;
wherein the second end of the clasp has a hinge;
c. a hinge pin;
wherein the hinge pin connects the hinge of the second end of the bottom of the clip to the hinge of the second end of the clasp;
d. a friction pad;
wherein the friction pad is provided on the interior surface of the side of the clip.

2. The claim as described in claim 1 wherein the device provides a plurality of integrated connectors.

3. The claim as described in claim 2 wherein the plurality of integrated connectors is provided on the exterior surface of the side of the clip.

4. The claim as described in claim 3 wherein a charm attaches to the plurality of integrated connectors.

5. The claim as described in claim 4 wherein the charm detaches from the plurality of integrated connectors.

6. The claim as described in claim 1 wherein a charm is affixed to the exterior surface of the side of the clip and is not detachable.

7. A device that is comprised of:
a. a clip;
wherein the clip provides a top, a side, and a bottom;
wherein the top has an exterior surface and an interior surface;
wherein the top has a first end and a second end;
wherein the second end of the top of the clip has a concave surface;
wherein the side has an exterior surface and an interior surface;
wherein the side has a first end and a second end;
wherein the bottom has an exterior surface and an interior surface;
wherein the bottom has a first end and a second end;
wherein the second end of the bottom has a hinge;
b. a clasp;
wherein the clasp has an exterior surface and an interior surface;
wherein the clasp has a first end and a second end;
wherein first end of the clasp has a convex surface;
wherein the convex surface fits within the concave surface;
wherein the second end of the clasp has a hinge
c. a hinge pin;
wherein the hinge pin connects the hinge of the second end of the bottom of the clip to the hinge of the second end of the clasp;
d. a plurality of integrated connectors;
wherein the plurality of integrated connectors is provided on the exterior surface of the side of the clip;
e. a friction pad;
wherein the friction pad is provided on the interior surface of the clasp.

8. The claim as described in claim 7 wherein the device provides a plurality of integrated connectors.

9. The claim as described in claim 8 wherein the plurality of integrated connectors is provided on the exterior surface of the side of the clip.

10. The claim as described in claim 9 wherein a charm attaches to the plurality of integrated connectors.

11. The claim as described in claim 10 wherein the charm detaches from the plurality of integrated connectors.

12. The claim as described in claim 7 wherein a charm is affixed to the exterior surface of the side of the clip and is not detachable.

13. An device that is comprised of:
a. a clip;
Wherein the clip provides a top, a side, and a bottom;
Wherein the top has an exterior surface and an interior surface;
Wherein the top has a first end and a second end;
wherein the second end of the top of the clip has a concave surface;
wherein the side has an exterior surface and an interior surface;
wherein the side has a first end and a second end;
wherein the bottom has an exterior surface and an interior surface;
wherein the bottom has a first end and a second end;
wherein the second end of the bottom has a hinge;
b. a clasp;
wherein the clasp has an exterior surface and an interior surface;
wherein the clasp has a first end and a second end;
wherein first end of the clasp has a convex surface;
wherein the convex surface fits within the concave surface;
wherein the second end of the clasp has a hinge;
c. a hinge pin;
Wherein the hinge pin connects the hinge of the second end of the bottom of the clip to the hinge of the second end of the clasp;
d. a first friction pad;
wherein the first friction pad is provided on the interior surface of the side of the clip,
e. a second friction pad;
wherein the second friction pad is provided on the interior surface of the clasp.

14. The claim as described in claim 13 wherein the device provides a plurality of integrated connectors.

15. The claim as described in claim 14 wherein the plurality of integrated connectors is provided on the exterior surface of the side of the clip.

16. The claim as described in claim 15 wherein a charm attaches to the plurality of integrated connectors.

17. The claim as described in claim 16 wherein the charm detaches from the plurality of integrated connectors.

18. The claim as described in claim 13 wherein a charm is affixed to the exterior surface of the side of the clip and is not detachable.
